(19) United States
(12) Patent Application Publication
(10) Pub. No.: US 2016/0009908 A1
(43) Pub. Date: Jan. 14, 2016

(54) RESIN COMPOSITION HAVING EXCELLENT SURFACE SMOOTHNESS

(71) Applicant: FURUKAWA ELECTRIC CO.,LTD., Tokyo (JP)

(72) Inventors: Hiroki CHIBA, Tokyo (JP); Koichi MIZUNO, Tokyo (JP); Tomoyuki SHIRAI, Tokyo (JP)

(73) Assignee: FURUKAWA ELECTRIC CO., LTD., Tokyo (JP)

(21) Appl. No.: 14/770,435

(22) PCT Filed: Feb. 25, 2014
(86) PCT No.: PCT/JP2014/054422

§ 371 Date: Aug. 25, 2015

(30) Foreign Application Priority Data
Feb. 27, 2013 (JP) 2013- 037156

(51) Int. Cl. C08L 23/06; H01B 3/44; H01B 13/14; C08L 23/12

(52) U.S. Cl. CPC C08L 23/06; C08L 23/12; H01B 3/441; H01B 13/14

(57) ABSTRACT

Solved is the following problem: a PE based resin including a film grade ethylene-α-olefin copolymer is excellent in economic efficiency, but has a narrow molecular weight distribution in consideration for strength and heat sealability, and therefore causes surface roughening to occur when applied to a covering material for an insulated electric wire or cable. Applied is a polyolefin based resin composition including at least one polyethylene (PE) based resin, in which, when a ratio (I₁₀/I_{0.5}) of an MFR (I₁₀) measured at 190° C. and a load of 10 kg to an MFR (I_{0.5}) measured at 190° C. and a load of 0.5 kg is defined as MFRR, a difference between the MFRR of the polyolefin based resin composition including at least one PE based resin and the MFRR of the PE based resin is 5 or more.

### TECHNICAL FIELD

The present invention relates to a resin composition for covered electric wire and cable to be produced by extrusion, and relates to a resin composition for protection and insulation of electric wire and cable, which can allow to produce covered electric wire and cable having a high economic efficiency and being excellent in surface smoothness while electric, thermal, dynamic and chemical properties are not impaired. The present invention also relates to a technique for applying a film grade polyolefin based resin to an insulating material or a cable sheath material of a covered electric wire.

### BACKGROUND ART

While electric wire and cable are, of course, used for a power transport medium, the amount thereof to be used for an information transmission medium is also remarkably increased in accordance with development of the information society and electronization of every equipment. Therefore, a plastic material that protects and insulates electric wire and cable is demanded to have a key role in allowing power transport and information transmission to function safely.

The power transport medium is divided to, for example, a transmission line that transmits electricity generated in a power plant to an electrical substation of a point of consumption, a distribution line that distributes electricity, whose voltage is reduced to a predetermined value at the electrical substation, to a factory, a building, a home or the like, furthermore, wiring for use in a factory, a building, a home or the like, and an electric wire for specialized equipment, for use in boat and ship, an airplane, an automobile or the like. On the other hand, examples of the information transmission medium include an optical cable for use in a main line between telephone stations, an optical and metal code/cable for use in a telephone station, an optical and metal cable for wiring between power poles, a cable to be drawn in a house, electric wire and cable for connection between electronic equipment in an office or a home, and a code for connection between audio-video equipment such as television. In recent years, the amount of electric wire and cable to be used in an electronic automobile has also been increased.

The protective insulating material for electric wire and cable of the present invention is mainly directed to the field of a distribution line of several hundreds V or less in power transport, and the fields of an optical cable for a main line, an optical and metal cable for local wiring, and code and cable for connection between electronic equipment in an office or a home, in information transmission, and three kinds: a vinyl chloride (PVC) resin, a polyethylene (PE) resin and a crosslinked PE resin; are mainly used currently in terms of properties and a cost. In such applications, while the protective insulating material is demanded to accomplish original objects with respect to electric insulation, protection and anticorrosion properties of an electric wire, and ease of handling of an electric wire and a cable, it is also demanded to be excellent in aesthetic appearance, low in cost (economic efficiency), efficient in covering (productivity) and compatible with the environment. The protective insulating material for electric wire and cable of the present invention is also of importance in terms of thermal and chemical properties such as impact resistance, wear resistance, weather resistance and oil resistance because of also being applied to a sheath layer for protection from the external environment to be provided in addition to an electric insulating layer provided on a conductor.

PE bearing such essential physical properties demanded for a protective insulating material for electric wire and cable has been studied from various viewpoints over many years. Such studies are closely related to the history of the development of PE (Non Patent Literatures 1 to 3). A large factor for them is also that PE is used in large amounts mainly in a packaging material or the like and is a material that is inexpensive and excellent in economic efficiency. An additional factor for them is that PE has been recently expected as an alternative material for PVC because of being free of halogen that causes a harmful substance to be generated.

Low density PE (LDPE) by a high pressure process, industrially produced in the 1930's, has been widely used as a protective insulating material for electric wire and cable because of being excellent in extrudability, having no problem in terms of outer appearance and having flexibility, but has been problematic in terms of wear resistance, weather resistance and the like.

In response to such a problem, application of high density PE (HDPE) with a Ziegler-Natta catalyst system industrially produced in the 1950's has been tried. HDPE has been, however, poor in extrudability to cause the problem in terms of outer appearance: surface roughening, referred to as melt fracture. In particular, such a problem has been remarkably caused in production at a high speed, making impossible to increase productivity. Therefore, as disclosed in Japanese Patent Laid-Open No. 58-111205 and Japanese Patent Laid-Open No. 61-148703, such a problem has been tried to be solved by a method of mixing HDPE with a polyolefin based resin having a different melt viscosity behavior, such as LDPE.

In the 1970's, linear LDPE (LLDPE) industrially produced by a gas phase polymerization process in the U.S., in particular, LLDPE produced by copolymerization of ethylene with α-olefin through a Ziegler-Natta catalyst has been excellent in mechanical strength, heat resistance and hot sealability as compared with LDPE, and has been superior in sealing strength, impact resistance, hot tack property and the like as compared with Surlyn (registered trademark, PE ionomer), and therefore conventional LDPE has been substituted with LLDPE mainly in a packaging material application. LLDPE, having a short-chain branched structure, has been expected as a material falling between linear HDPE almost not branched and LDPE having many long chain branches, which covers the shortcomings of both of them, also in an application of a protective insulating material of electric wire and cable. LLDPE, however, having the problem in terms of outer appearance referred to as melt fracture as in HDPE, has been improved by a method of mixing with LDPE or a different kind of LLDPE as disclosed in, for example, Japanese Patent Laid-Open No. 60-110739 and Japanese Patent Laid-Open No. 6-52719.

Furthermore, LLDPE produced by copolymerization of ethylene with α-olefin through a metallocene catalyst developed by Professor Kaminsky et al. in 1980, having a narrower molecular weight distribution and being more excellent in low-temperature sealability and strength than the above LLDPE, has been industrially produced in the 1990's and has been necessary as a packaging material in the 2000's, and the amount of LLDPE to be used in a film application has been enormous. In particular, application to a protective insulating material for electric wire and cable has been studied in terms of economic efficiency, but a special melt viscosity behavior generated by a narrow molecular weight distribution has caused the problem of melt fracture in extrusion to be remarkable, and there have been made improvements by the development of LLDPE having a new branched structure as disclosed in, for example, National Publication of International Patent Application No. 1995-500622 and National Publication of International Patent Application No. 2000-508466, and by mixing of a different polyolefin based resin, a thermoplastic elastomer (TPE) and the like as disclosed in Japanese Patent Laid-Open No. 2007-177183 and the like.

Japanese Patent Laid-Open No. 6-52719 has disclosed the physical property value where no melt fracture is caused, in definition of the ratio of the melt flow rate (MFR) (I_{21.6}) measured at 190° C. and a load of 21.6 kg to the MFR (I_{2.16}) at 190° C. and a load of 2.16 kg as the melt flow rate ratio (MFRR) according to JIS K 7210, but only formation of a sheet by pressing has been performed and the above problem in terms of outer appearance of covered electric wire and cable has not still been solved. In fact, as described later, it has been found that a resin composition which can solve the problem of melt fracture in production at a high linear speed has an increased discharge speed under conditions of 190° C. and 21.6 kg to make precise measurement impossible.

National Publication of International Patent Application No. 1995-500622 and National Publication of International Patent Application No. 2000-508466 have disclosed the physical property value where no melt fracture is caused, in definition of the ratio (I₁₀/I₂) of the MFR (I₁₀) measured at 190° C. and a load of 10 kg to the MFR (I₂) measured at 190° C. and a load of 2 kg as the melt flow rate ratio (MFRR) according to ASTM D-1238. In the former case, 5.63≦I₁₀/I₂ is satisfied, and in the latter case, 7.0≦I₁₀/I₂≦16.0 is satisfied. In the former case, however, only film processing has been performed, and no evaluation as a material for covering electric wire and cable has been performed. In the latter case, while the electric wire-covering test has been performed, the visual evaluation results have been merely quantified, and the degree of surface roughness has not been seen and furthermore the improvement effect with such quantification has been only about 20%. Moreover, these cases relate to not a blend of two or more resins but one PE based resin obtained by polymerization in one synthesis apparatus.

The MFRRs according to JIS K 7210 and ASTM D-1238 are set for roughly providing various processing conditions, and are not set for the purpose of solving the problem of melt fracture in production of covered electric wire and cable by extrusion using a polyolefin based resin composition mainly including PE. Accordingly, a resin composition identified by the MFRRs under such measurement conditions does not solve the problem of melt fracture.

That is, even various improvements described above have not provided a polyolefin based resin composition mainly including a PE based resin, which can simultaneously solve the problem in terms of physical properties such as wear resistance and weather resistance and the problems in terms of outer appearance (surface smoothness) and economic efficiency, and no melt viscosity behavior suitable for extrusion has been identified.

### CITATION LIST

### Patent Literatures

Patent Literature 1: Japanese Patent Laid-Open No. 58-111205
Patent Literature 2: Japanese Patent Laid-Open No. 61-148703
Patent Literature 3: Japanese Patent Laid-Open No. 60-110739
Patent Literature 4: Japanese Patent Laid-Open No. 6-52719
Patent Literature 5: National Publication of International Patent Application No. 1995-500622
Patent Literature 6: National Publication of International Patent Application No. 2000-508466
Patent Literature 7: Japanese Patent Laid-Open No. 2007-177183

### Non Patent Literatures

Non Patent Literature 1: Recent Trend and Near Future Direction of Plastic Material Technology in Progress of High Functionalization, edited by Takeo YASUDA, Industrial Material, vol. 53, No. 4, 18 (2005)
Non Patent Literature 2: Prospect of Japan Plastic Industry in 2006, “Polyethylene”, Plastic Editorial Department, Plastics, 57 (1), 27 (2006)
Non Patent Literature 3: Latest Trend of Metallocene Polyethylene, edited by Takuya SERI, Convertech, 32 (10), 76 (2004)
Non Patent Literature 4: Engineering Plastics-Characteristics and Processing, edited by Yasushi OYANAGI, p.p. 74 (1985)
Non Patent Literature 5: Polymer Chemistry Introduction, edited by Seizo OKAMURA (and other six persons) (second edition), p.p. 155 (1981)

### SUMMARY OF INVENTION

### Technical Problem

An object of the present invention is to provide a protective insulating material that is a polyolefin based resin including at least one film grade PE based resin mainly for use in a packaging material and the like, that can have economic efficiency and productivity while physical properties demanded for covered electric wire and cable are not impaired, and that can be used to produce covered electric wire and cable excellent in surface smoothness.

Another object of the present invention is to provide a resin composition having melt viscoelasticity which enables to exhibit surface smoothness when a polyolefin based resin composition including at least one PE based resin is applied to extrusion as a protective insulating material for covered electric wire and cable.

### Solution to Problem

The present inventors have found that a resin composition satisfying the melt flow rate difference (MFRD) defined below as a new parameter that represents melt viscoelasticity can solve the problem in terms of surface smoothness of a resin covered electric wire (including insulated electric wire and cable) in extrusion. First, a ratio (I₁₀/I_{0.5}) of an MFR (I₁₀) measured at 190° C. and a load of 10 kg to an MFR (I_{0.5}) measured at 190° C. and a load of 0.5 kg is defined as MFRR, and second, when the MFRR of the resin composition for protection and covering, including two or more polyolefin based resins, is designated as (A) and the MFRR of one PE based resin in the above polyolefin system is designated as (a), MFRD=(A)−(a) is defined.

That is, the present inventors have found that the above problems are solved by a polyolefin based resin composition including at least one PE based resin, satisfying MFRD 5, and have completed the present invention as a technical idea.

### Advantageous Effects of Invention

According to the present invention, a polyolefin based resin composition including various PE based resins, in particular, a film grade ethylene-α-olefin copolymer can be applied to a protective insulating material for covered electric wire and cable.

Moreover, according to the present invention, covered electric wire and cable can be provided which is high in productivity, in addition to economic efficiency, and are excellent in aesthetic outer appearance because not only a PE based resin composition excellent in economic efficiency can be used, but also there is caused no problem of melt fracture even in production at a high speed.

### BRIEF DESCRIPTION OF DRAWINGS

FIG. 1 is a graph in which the arithmetic average roughness (Ra, μm) and the MFRD=(A)−(a) are plotted on the vertical axis and the horizontal axis, respectively, based on the results in Table 2.

### DESCRIPTION OF EMBODIMENTS

Hereinafter, embodiments of the present invention are described.

The present inventors have considered in the course of investigation of the relationship between the melt viscosity behavior and the melt fracture of various resin compositions that, while the MFRRs disclosed in National Publication of International Patent Application No. 1995-500622 and National Publication of International Patent Application No. 2000-508466 cannot allow the above problems to be solved, it is significant to focus on the physical property value MFRR associated with the regularity of a molecular structure and a new parameter related to the melt viscoelasticity behavior can allow the above problems to be solved.

This is because we considered that the problem of melt fracture in extrusion of covered electric wire and cable obtained by extrusion using a polyolefin based resin composition is presumed to be caused as follows and the following is closely related to the MFRR.

First, while there are various theories about the cause of melt fracture by extrusion, it is known that melt fracture occurs physically when the shear stress on the wall surface of a die nozzle excesses the critical shear stress of a resin, and this is presumed to be caused based on the following. The first theory is that high speed extrusion causes uneven convection to occur near a nozzle inflow part. The second theory is that the difference in molecular orientation between the periphery portion in contact with the wall surface of the nozzle and the inside of the nozzle in the nozzle causes the difference in shrinkability between the periphery and the inside. In addition, the third theory is that a stick-slip phenomenon occurs due to friction with the wall surface of the die. On the other hand, it is presumed with the rheological consideration that, when a polyolefin based resin composition molten in an extruding machine is discharged outside through a nozzle of the extruding machine, the normal stress effect specific to a viscoelastic body is exerted to provide a large and protuberant form, and the temperature of the resin composition is rapidly dropped to result in solidification, causing the protuberant form by the normal stress effect to remain. This is understood from the following: melt fracture is more drastically caused in HDPE and LLDPE than LDPE due to a higher speed of the solidification, and furthermore in HDPE and LLDPE having a narrower molecular weight distribution by use of a metallocene catalyst than LDPE. In particular, as in production of covered electric wire and cable, the Baras effect that is a specific swelling phenomenon observed in pore extrusion (Non Patent Literature 4) is more remarkably exerted in high speed extrusion for an increase in productivity.

While this is based on the regularity of a primary molecular structure associated with the branch structure and the molecular weight distribution of each of LDPE, LLDPE, LLDPE with a metallocene catalyst system, and HDPE, as described above, it is considered to be important to focus on rheology, in particular, a melt viscoelasticity behavior as a macro physical property with respect to the objects of the present invention related to the forming technique of a polymer as a viscoelastic body. In particular, in the case of a resin having a broad molecular weight distribution, it is known that a low molecular component can serve as a lubricant to result in the change in melt viscoelasticity behavior, thereby suppressing melt fracture.

Then, the present inventors have focused on the MFRR reported to have a correlation with the molecular weight distribution, namely, the regularity of a molecular structure, and have made studies based on the following: the MFRR can be defined by an optimal condition and a new parameter can be set to thereby allow the correlation between the viscoelasticity behavior and the regularity of a molecular structure in application of the shear stress to be grasped, solving the problem of melt fracture in extrusion. The reason why the present inventors have focused on the MFRR is because the viscoelasticity behavior can be simply evaluated unlike gel permeation chromatography (GPC), a rheometer and the like.

The present inventors have used a polyolefin based resin composition including at least one of various PE based resins, have measured MFRs under various conditions and have made detailed studies about surface smoothness of a covered electric wire obtained by extrusion, and as a result, have found that, when a ratio (I₁₀/I_{0.5}) of an MFR (I₁₀) measured at 190° C. and a load of 10 kg to an MFR (I_{0.5}) measured at 190° C. and a load of 0.5 kg is used as MFRR, the difference between the MFRR (A) of the polyolefin based resin composition including at least one PE based resin and the MFRR (a) of the PE based resin, namely, MFRD is an optimal parameter.

First, MFRR=I₁₀/I_{0.5} defined in the present invention is based on an improvement in extrusion pressure of a resin in measurement of the MFRs of MFRR=I_{21.6}/I_{2.16} and MFRR=I₁₀/I₂ disclosed in Japanese Patent Laid-Open No. 6-52719 and National Publication of International Patent Application No. 2000-508466, respectively. A resin composition that can overcome melt fracture cannot precisely measure I_{21.6}. The present inventors have also found that the range of a load in measurement of the MFR in I₂ is too narrow. This is based on the following: the viscoelasticity behavior is expressed as a function of the experimental time and also as a function of the temperature and such functions are correlated (Non Patent Literature 5). Qualitatively, it is indicated that a higher speed of the stress applied to a viscoelastic body such as a resin corresponds to an effect of decreasing the temperature of the resin to which the stress is applied, and on the contrary, it is indicated that a lower speed of the stress applied to the resin corresponds to an increase in the temperature of the resin to which the stress is applied.

When this is considered with respect to the MFR, it can be said that, when the load is larger, the discharge speed of the resin is higher and such a behavior corresponds to the viscoelasticity behavior at a lower temperature of the resin, and when the load is smaller, the discharge speed of the resin is lower and such a behavior corresponds to the viscoelasticity behavior at a higher temperature of the resin. Accordingly, the MFRR defined in the present invention, which is the ratio of the MFR at a load of 0.5 kg to that at a load of 10 kg, means that the viscoelasticity behavior is evaluated in a wider temperature range than that of the prior art.

The present inventors have made further various studies, and as a result, have found that the difference between the MFRR=(A) of the polyolefin based resin composition including at least one PE based resin and the MFRR=(a) of the PE based resin, namely, MFRD=(A)−(a) is in good relationship with the surface smoothness of covered electric wire and cable produced in extrusion.

That is, the present invention is a polyolefin based resin composition in which, when the MFRR of the resin composition for protection and covering, including two or more polyolefin based resins, is designated as (A) and the MFRR of the film grade PE based resin is designated as (a), MFRD=(A)−(a) is 5 or more. The theoretical evidence of this parameter, however, is not clear, and is transferred to future research.

One shown below can be used for the polyolefin based resin composition including at least one PE based resin, but any combination of resins may be used without particular limitation as long as MFRD=(A)−(a) 5 is satisfied.

Each of HDPE, LLDPE, MDPE and LDPE can be used for the PE based resin as long as the above MFRD is satisfied.

In consideration for economic efficiency, however, a film grade PE based resin, in particular, a mixture of two or more polyolefin based resins including at least one ethylene-α-olefin copolymer is preferable. In particular, examples of the ethylene-α-olefin copolymer in the present invention include a copolymer of ethylene with an α-olefin having 4 to 12 carbon atoms, and a copolymer with an α-olefin such as 1-butene, 1-hexene, 4-methyl-1-pentene, 1-octene, 1-decene and 1-dodecene is used. Such a copolymer is preferably, for example, LDPE, LLDPE, MDPE, and LLDPE synthesized with a metallocene catalyst system, more preferably film grade one.

Moreover, the resin density of the ethylene-α-olefin copolymer in the present invention is, but not particularly limited, preferably 0.880 to 0.940 g/cm³. In the case of such a resin density, flexibility, low-temperature impact resistance, and the like of an insulated electric wire or cable can be achieved.

Examples of a commercial product of the ethylene-α olefin copolymer in the present invention can include “Kernel” (trade name, produced by Japan Polyethylene Corporation), “Evolue” (trade name, produced by Prime Polymer Co., Ltd.), “Moretec” (trade name, produced by Prime Polymer Co., Ltd.), HONAM UF315 (trade name, produced by Honam Petrochemical Corp.), HONAM UF927 (trade name, produced by Honam Petrochemical Corp.), Suntec (trade name, produced by Asahi Kasei Chemicals Corporation), Umerit (trade name, produced by Ube-Maruzen Polyethylene), Sumikasen (trade name, produced by Sumitomo Chemical Co., Ltd.) and Nipolon (trade name, produced by Tosoh Corporation).

The polyolefin based resin composition including at least one PE based resin preferably includes at least one PP based resin. This PP based resin is more preferably one having an MFR (at 190° C. and a load of 2.16 kg) of 1 to 100 g/10 min, further preferably 5 to 80 g/10 min, most preferably 10 to 63 g/10 min.

The ratio thereof to be compounded is preferably PE based resin:PP based resin=97 to 50:3 to 50 (parts by mass), further preferably 95 to 80:5 to 20 (parts by mass). Such a compounding ratio can provide a resin composition having melt viscoelasticity suitable for extrusion, resulting in a reduction of melt fracture without causing physical properties demanded for covered electric wire and cable, such as flexibility and cold resistance, to be impaired.

For the PP based resin, a propylene homopolymer (homo PP resin), an ethylene-propylene random copolymer, an ethylene-propylene block copolymer, and the like can be used. A copolymer with 1-butene and a terpolymer with ethylene and 1-butene can also be used. The random copolymer here refers to one in which a component other than propylene is randomly incorporated in the propylene chain in a content of about 1 to 5% by mass. In addition, the block copolymer here refers to one having a sea-island structure in which a component other than propylene is independently present in the propylene component in a content of about 5 to 15% by mass.

Examples of a commercial product of such a PP based resin include products such as “Novatec PP” (trade name, produced by Japan Polypropylene Corporation), “Sunallomer” (trade name, produced by Sunallomer Ltd.) polypropylene, “Noblen” (trade name, produced by Sumitomo Chemical Co., Ltd.) and “Prime Polypro” (trade name, produced by Prime Polymer Co., Ltd.).

Various additives such as an antioxidant, a metal deactivator, a flame retardant (aid), a filler and a lubricant commonly used in an electric wire, a cable, a code, a tube, an electric wire component, a sheet, and the like can be appropriately compounded in the polyolefin based resin composition of the present invention as long as the object of the present invention is not impaired.

Examples of the antioxidant include amine based antioxidants such as polymers of 4,4′-dioctyl diphenylamine, N,N′-diphenyl-p-phenylenediamine and 2,2,4-trimethyl-1,2-dihydroquinoline, phenol based antioxidants such as pentaerythritol-tetrakis(3-(3,5-di-t-butyl-4-hydroxyphenyl)propionate), octadecyl-3-(3,5-di-t-butyl-4-hydroxyphenyl)propionate and 1,3,5-trimethyl-2,4,6-tris(3,5-di-t-butyl-4-hydroxybenzyl)benzene, bis(2-methyl-4-(3-n-alkylthiopropionyloxy)-5-t-butylphenyl)sulfide, 2-mercaptobenzimidazole and zinc salts thereof, and sulfur based antioxidants such as pentaerythritol-tetrakis(3-lauryl-thiopropionate).

Examples of the metal deactivator include N,N′-bis(3-(3,5-di-t-butyl-4-hydroxyphenyl)propionyl)hydrazine, 3-(N-salicyloyl)amino-1,2,4-triazole and 2,2′-oxamidebis-(ethyl 3-(3,5-di-t-butyl-4-hydroxyphenyl)propionate).

Examples of the lubricant include hydrocarbon based, fatty acid based, fatty acid amide based, ester based, alcohol based and metal soap based lubricants, and silicone gum.

Production of the covered electric wire and cable by extrusion using the resin composition is performed as follows, but is not limited to the following. A PE based resin pellet and other resin pellet are mixed immediately above an extruding machine, and fed through a hopper. The resin composition fed is extruded with being molten by a screw, and a conductor and a covered electric wire are covered with the resin composition in a cross head, and discharged.

At least one additive such as a colorant, an antioxidant and a lubricant is added to a polyolefin based resin other than the PE based resin, and the resultant is molten and mixed by a Bunbury mixer or an extruder to prepare a polyolefin based resin pellet. Next, this pellet is mixed with a pellet of the PE based resin immediately above an extruding machine, and the resulting mixture is fed through a hopper. The resin composition fed is extruded with being molten by a screw, and a conductor and a covered electric wire are covered with the resin composition in a cross head, and discharged.

On the other hand, the extruding machine for use in production of the covered electric wire and cable of the present invention is not specialized, and a general-purpose extruding machine for production of an electric wire can be used therefor. The temperature of the extruding machine is preferably as follows: the temperature in a cylinder is about 160 to 200° C. and the temperature of a cross head is about 180 to 220° C.

Furthermore, in order to more enhance dynamic, thermal and chemical properties, the covered electric wire may also be subjected to radiation crosslinking in the present invention. γ-Ray and/or electron beam can be used for the source of radiation, conventionally common apparatus and method can be used, and the density of crosslinking is required to be set depending on the intended application.

Hereinabove, the electric wire-covering material of the present invention is mainly directed to the fields of a distribution line of several hundreds V or less in power transport, and a communication cable for connection between stations and an electric wire for connection between electronic equipment in an office or a home in information transmission, but encompasses all with which the periphery of conductors is covered as an electric wire-covering layer, and the structure thereof is not particularly limited. The thickness of the covering layer, the thickness of each conductor, the number of conductors, and the like are not particularly different from conventional ones. These can be appropriately set depending on the type and the application of an electric wire.

### Examples

Hereinafter, the present invention is specifically described with reference to Examples of the present invention and Comparative Examples.

### Samples

Polyolefin based resins used in Examples 1 to 8 and Comparative Examples 1 to 5 were shown in Table 1. An ethylene-1 butene copolymer was used as the film grade ethylene-α-olefin copolymer, and each of h-PP, r-PP and b-PP was used as the PP based resin.

TABLE 1
Samples

| | Abbreviations | | | | |
|---|---|---|---|---|---|
| Compounds | and names | Manufacturers | Grade | MFR | Density |
| Ethylene-α-olefin copolymer | PE based resin | HONAM | UF-315 | 1.1 | 0.920 |
| PP homopolymer | h-PP | Sunallomer Ltd. | PM900A | 30 | 0.900 |
| PP based random polymer | r-PP | Sunallomer Ltd. | PMA20V | 45 | 0.900 |
| PP based block polymer | b-PP | Sunallomer Ltd. | PMA60Z | 45 | 0.900 |

### [Preparation of Resin Composition]

A pellet mixture of the PE based resin and each of the PP based resins was prepared in each compounding ratio shown in Table 2. First, additives such as a colorant, an antioxidant and a lubricant were added to each of the PP based resins, and the resultant was molten and mixed by a Bunbury mixer to prepare each of PP based resin pellets. Next, each of the PP based resin pellets prepared was dry-blended with the PE based resin to provide a pellet mixture of a resin composition for covering an electric wire.

### [Production of Covered Electric Wire]

The pellet of a resin composition for covering an electric wire was fed into an extruding machine for production of an electric wire, and an annealed copper wire having a conductor diameter of 0.8 mm was covered therewith in a thickness of 0.8 mm by extrusion under conditions of cylinder temperatures of 160° C., 170° C. and 210° C. sequentially closer to a feeder, and a cross head temperature of 220° C., to produce a covered electric wire. The speed of the extrusion was 8 m/min.

### [Evaluations]

The MFR of each of the resins was measured at a temperature of 190° C. and each of loads of 10 and 0.5 kg according to JIS K 7210, and the MFRR=I₁₀/I_{0.5} was determined therefrom.

In addition, with respect to the surface shape of each of the electric wires produced, sampling was made at five points randomly and the surface roughness at each of the sampling points was measured using a surface roughness measurement machine (Surftest SJ-301 manufactured by Mitutoyo Corporation) according to JIS B 0601 to determine the arithmetic average roughness (Ra, μm).

### [Results]

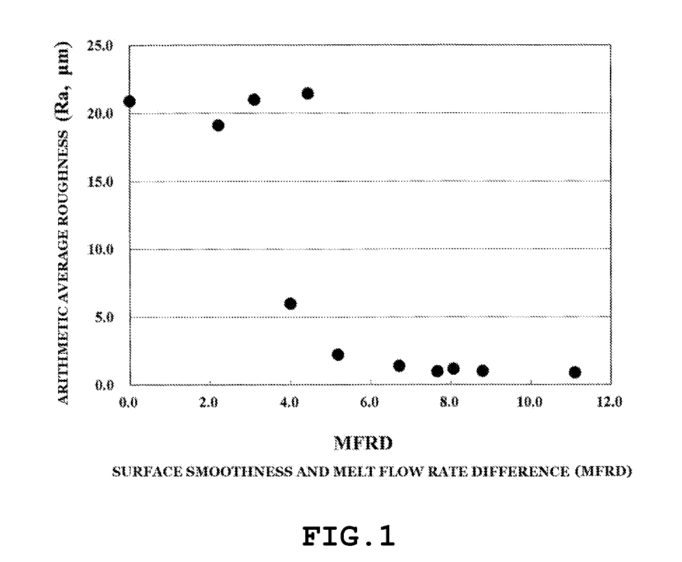

The measurement results and the parameters calculated were summarized in Table 2. In FIG. 1, the arithmetic average roughness (Ra, μm) was plotted on the vertical axis and the MFRD=(A)−(a) was plotted on the horizontal axis based on the results in Table 2.

TABLE 2
Relationship between surface smoothness and melt flow rate difference

| | | a | A = a + b | | | | | | | | | |
|---|---|---|---|---|---|---|---|---|---|---|---|---|
| | | Compar- | Compar- | Compar- | | | Compar- | | | Compar- | | |
| | | ative | ative | ative | | | ative | | | ative | | |
| | | Example 1 | Example 2 | Example 3 | Example 1 | Example 2 | Example 4 | Example 5 | Example 6 | Example 5 | Example 7 | Example 8 |
| a | UF-315 | 100 | 99 | 97 | 95 | 90 | 99 | 97 | 95 | 99 | 97 | 95 |
| b | h-pp | 0 | 1 | 3 | 5 | 10 | | | | | | |
| | r-pp | | | | | | 1 | 3 | 5 | | | |
| | b-pp | | | | | | | | | 1 | 3 | 5 |

| MFR = I_{0.5} | | 0.2 | 0.2 | 0.2 | 0.2 | 0.3 | 0.2 | 0.2 | 0.2 | 0.2 | 0.2 | 0.2 |
|---|---|---|---|---|---|---|---|---|---|---|---|---|
| MFR = I₁₀ | | 8.7 | 9.5 | 9.8 | 10.6 | 12.3 | 9.3 | 9.9 | 11.1 | 8.9 | 9.9 | 10.3 |
| MFRR = I₁₀/_{10.5} | | 38 | 41 | 42 | 46 | 49 | 42 | 43 | 47 | 40 | 45 | 46 |
| [(a), (A)] | | | | | | | | | | | | |
| MFRD = | | 0 | 3 | 4 | 8 | 11 | 4 | 5 | 9 | 2 | 7 | 8 |
| (A) − (a) | | | | | | | | | | | | |
| Arithmetic | 1 | 19.2 | 18.0 | 2.6 | 1.0 | 0.7 | 25.0 | 2.1 | 1.0 | 19.7 | 1.0 | 1.0 |
| average | 2 | 21.4 | 28.6 | 6.0 | 1.1 | 1.1 | 19.5 | 1.7 | 1.0 | 8.5 | 2.0 | 1.5 |
| roughness | 3 | 26.3 | 17.1 | 5.3 | 0.9 | 0.7 | 16.0 | 5.3 | 0.9 | 24.1 | 1.1 | 1.1 |
| (Ra, μm) | 4 | 18.4 | 19.8 | 6.2 | 1.1 | 0.9 | 23.7 | 1.3 | 1.0 | 21.1 | 1.5 | 1.4 |
| | 5 | 19.3 | 21.6 | 9.9 | 1.0 | 1.1 | 23.2 | 0.9 | 1.2 | 22.3 | 1.4 | 1.0 |
| | Ave | 20.9 | 21.0 | 6.0 | 1.0 | 0.9 | 21.5 | 2.2 | 1.0 | 19.1 | 1.4 | 1.2 |

As is clear from Table 2 and FIG. 1, when the MFRD=(A)−(a) was 5 or more, the surface roughness was rapidly decreased, and was reduced to about a twentieth thereof in calculation of Ra.

### INDUSTRIAL APPLICABILITY

The polyolefin based resin composition of the present invention and the covered electric wire and cable produced using the polyolefin based resin composition can be utilized for an insulating material or a sheath material in the wide fields of a distribution line of several hundreds V or less in power transport and an electric wire for connection between electronic equipment in an office or a home in information transmission, in terms of properties and a cost.

In addition, the present invention not only can be expected, with respect to a resin composition for covering an electric wire and a covered electric wire using the resin composition, to sufficiently exhibit superiority in productivity, marketability, functionality and the like in every electrical and electronic equipment industries, in addition to power transport and information transmission industries, but also can be widely applied to an optical code, a power plug, a connector, a sleeve, a box, a tape, a tube, a sheet and the like, and therefore is large in industrial applicability.

1. A polyolefin based resin composition for covering insulated electric wire and cable, comprising at least one polyethylene (PE) based resin, wherein, when a ratio I₁₀/I_{0.5} of a melt flow rate (MFR) (I₁₀) measured at 190° C. and 10 kg to an MFR (I_{0.5}) measured at 190° C. and 0.5 kg is defined as a melt flow rate ratio (MFRR), a difference between an MFRR (A) of the polyolefin based resin composition comprising at least one PE based resin and an MFRR (a) of the PE based resin is 5 or more.

2. The polyolefin based resin composition for covering insulated electric wire and cable according to claim 1, wherein the PE based resin is an ethylene-α olefin copolymer, and a polyolefin based resin other than the PE based resin is a polypropylene (PP) based resin.

3. The polyolefin based resin composition for covering insulated electric wire and cable according to claim 2, wherein an MFR at 190° C. and a load of 2.16 kg of the PP based resin is 1 to 100 g/10 min.

4. A resin covered wire, wherein the polyolefin based resin composition for covering insulated electric wire and cable according to claim 1 is used.

5. A resin covered electric wire wherein the PE based resin recited in claim 1 and a polyolefin based resin other than the PE based resin are mixed immediately above an extruder, and subjected to extrusion.

6. The resin covered electric wire according to claim 4, wherein the polyolefin based resin other than the PE based resin comprises at least one of an antioxidant, carbon, a colorant and a lubricant.

7. A method for manufacturing a resin covered electric wire comprising mixing the PE based resin recited in claim 1 and a polyolefin based resin other than the PE based resin immediately above an extruder, and subjecting the resultant mixture to extrusion.

8. A resin covered wire, wherein the polyolefin based resin composition for covering insulated electric wire and cable according to claim 2 is used.

9. A resin covered wire, wherein the polyolefin based resin composition for covering insulated electric wire and cable according to claim 3 is used.

10. A resin covered electric wire wherein the PE based resin recited in claim 2 and a polyolefin based resin other than the PE based resin are mixed immediately above an extruder, and subjected to extrusion.

11. A resin covered electric wire wherein the PE based resin recited in claim 3 and a polyolefin based resin other than the PE based resin are mixed immediately above an extruder, and subjected to extrusion.

12. A method for manufacturing a resin covered electric wire comprising mixing the PE based resin recited in claim 2 and a polyolefin based resin other than the PE based resin immediately above an extruder, and subjecting the resultant mixture to extrusion.

13. A method for manufacturing a resin covered electric wire comprising mixing the PE based resin recited in claim 3 and a polyolefin based resin other than the PE based resin immediately above an extruder, and subjecting the resultant mixture to extrusion.
